(19) United States
(12) Patent Application Publication
(10) Pub. No.: US 2026/0127496 A1
(43) Pub. Date: May 7, 2026

(54) SYSTEM AND METHOD FOR TARGETED MESSAGING AND OFFERS VIA MOBILE AND ADVERTISING PLATFORMS

(71) Applicant: Dine Savvy LLC, Jupiter, FL (US)

(72) Inventors: Jennifer GANTHER, Jupiter, FL (US); Myles LEIGHTON, Lakeway, TX (US)

(21) Appl. No.: 19/378,951

(22) Filed: Nov. 4, 2025

Related U.S. Application Data
(60) Provisional application No. 63/715,783, filed on Nov. 4, 2024.

(51) Int. Cl. G06N 20/00; G06Q 30/0251

(52) U.S. Cl. CPC G06N 20/00; G06Q 30/0267

(57) ABSTRACT

Digital marketing and customer relationship management systems, particularly to systems and methods designed for businesses to send targeted messages, referred to as “Nudges™” and “Reverse Nudges™” to engage customers, enhance customer loyalty, and increase sales through personalized offers and interactions. The system includes a “Dine Savvy™ Media Feed”—an AI-powered social content platform that aggregates and personalizes dining-related Posts, Nudges™, Super Nudges™, and Savvy Nudges™ using Vibe Vector-based emotional matching, contextual targeting, aesthetic refinement, and automated moderation.

### CROSS-REFERENCE TO RELATED APPLICATIONS

This application claims the benefit of priority under 35 U.S.C. § 119(e) to U.S. Provisional Ser. No. 63/715,783 , filed Nov. 4, 2024, titled “System and Method for Targeted Messaging and Offers via Mobile and Advertising Platforms,” the contents of which are incorporated herein by reference in their entirety.

### FIELD OF THE INVENTION

The present invention relates generally to digital marketing and customer relationship management systems, particularly to a system and method designed for businesses to send targeted messages, referred to as “Nudges™” to engage customers, enhance customer loyalty, and increase sales through personalized offers and interactions. The invention further includes a social media feed system, referred to as the “Dine Savvy™ Media Feed,” that aggregates and personalizes content from brands, merchants, and consumers using AI-driven contextual ambiance targeting.

### BACKGROUND

In today's modern era, consumers use web-based apps and smartphone-based apps to order food from restaurants on a regular and frequent basis. In certain areas, there are thousands of existing restaurants to choose from, and accordingly, consumers are often left with a decision of which restaurant to choose. Such a situation can be frustrating, especially when traveling, out with friends, or worse, on a date.

On the restaurant side of a commercial exchange, restaurants need to direct consumers to their restaurants to purchase and consume food produced by the restaurant, and due to large restaurant competition, that exists.

Accordingly, there is a need to connect consumers with restaurants according to the consumer's dining preferences through web-based and smartphone-based apps, to drive sales to restaurants, and to help users choose the specific restaurant to dine-in at or to order from.

Furthermore, there is a need for targeted digital marketing provided by restaurants to consumers, based upon consumer preferences through customized marketing and promotion, to drive business to restaurants to create increased sales and revenues for restaurants.

Furthermore, this is a need for digital targeted marketing provided by restaurants to consumers, based upon consumer preferences through customized marketing and promotion to drive business to restaurants to create increased sales and revenues for restaurants.

### SUMMARY OF THE INVENTION

Accordingly, it is an object of the invention to provide customized digital marketing and targeted marketing to consumers.

It is an object of the invention to provide a business-facing system for creating and distributing Nudges™ and a customer-facing system for receiving personalized offers. A “Nudge™” is an inventive system and method for businesses to send targeted messages and offers to their customers.

It is an object of the invention to provide a “Reverse Nudge™” feature which allows consumers to solicit offers from businesses.

It is an object of the invention to provide a “Dine Savvy™ Media Feed”—a social media-style content aggregation and personalization system and method that delivers hyper-personalized dining-related content including Posts, Nudges™, Super Nudges™, and Savvy Nudges™, using a multi-stage AI pipeline based on “Vibe Vectors,” dynamic user profiling, aesthetic refinement, and automated content moderation.

It is an object of the instant invention to provide a system for generating and personalizing a media feed comprising: at least one hardware processor; and a non-transitory computer-readable storage medium having stored thereon program instructions, the program instructions executable by the at least one hardware processor to: receive a plurality of content items from a plurality of sources; generate a Vibe Vector for each content item using a trained machine learning model; generate a User Vibe Vector based on user behavior, preferences, and context; compute similarity scores between the User Vibe Vector and each content item's Vibe Vector; rank and filter content based on said similarity scores and contextual relevance; apply aesthetic refinement to selected content using generative AI; perform automated content moderation; and output a personalized media feed to the user.

It is an object of the invention to provide customized digital marketing and targeted messaging to consumers based on preferences, behavior, and context.

It is object of the invention to provide a business-facing system for creating and distributing Nudges™ (targeted messages and offers) and a customer-facing system for receiving personalized offers, including integration with advertising platforms and mobile applications.

It is an object of the invention to provide a “Reverse Nudge™” feature that allows consumers to solicit offers from businesses.

It is an object of the present invention to provide a “Nudge™ direct communication system” that enables businesses (including suppliers, distributors, and merchants) to communicate offers or Nudges™ directly to “on-the-go” customers in a non-intrusive manner, with categories such as promotions, events, food waste reduction (“save the planet”), “the lonely bartender,” free drinks, free à la carte items, and custom Nudges™, as integrated across supply chains and delivered via internal push notifications or external advertising.

It is an object of the instant invention to provide a system comprising: at least one hardware processor; and a non-transitory computer-readable storage medium having stored thereon program instructions, the program instructions executable by the at least one hardware processor to: receive product or service information from a business and customer preference information from a database; generate transformations of the product or service information; apply a trained machine learning model to obtain classifications and confidence scores based on customer preferences; compute a consensus classification and confidence score; construct and use a re-training dataset; and output personalized offers (Nudges™) to customers via the Internet, mobile apps, or advertising platforms.

It is an object of the instant invention to provide a method comprising: receiving product or service information from a business and customer preference information from a database; generating transformations of the product or service information; applying a trained machine learning model to obtain classifications and confidence scores based on customer preferences; computing a consensus classification and confidence score; constructing and using a re-training dataset; and outputting personalized offers (Nudges™) to customers via the Internet, mobile apps, or advertising platforms.

It is an object of the instant invention to provide a computer program product comprising: a non-transitory computer-readable storage medium having program instructions embodied therewith, the program instructions executable by at least one hardware processor to: receive product or service information from a business and customer preference information from a database; generate transformations of the product or service information; apply a trained machine learning model to obtain classifications and confidence scores based on customer preferences; compute a consensus classification and confidence score; construct and use a re-training dataset; and output personalized offers (Nudges™) to customers via the Internet, mobile apps, or advertising platforms.

It is a further object of the invention to provide a “Dine Savvy™ Media Feed”—a social media-style content aggregation and personalization system and method that delivers hyper-personalized dining-related content including Posts, Nudges™, Super Nudges™, and Savvy Nudges™, using a multi-stage AI pipeline based on “Vibe Vectors,” dynamic user profiling, aesthetic refinement, and automated content moderation, as depicted in FIGS. 8 and 9.

It is an object of the instant invention to provide a system for generating and personalizing a media feed comprising: at least one hardware processor; and a non-transitory computer-readable storage medium having stored thereon program instructions, the program instructions executable by the at least one hardware processor to: receive content items from multiple sources (brands, merchants, consumers); generate Vibe Vectors for content and users using a trained machine learning model; compute similarity scores based on user behavior, preferences, location, and context; rank, filter, and refine content aesthetically using generative AI; perform automated moderation; and output a personalized media feed integrating targeted Nudges™.

### BRIEF DESCRIPTION OF THE FIGURES

The accompanying drawings, which are incorporated in and constitute a part of this specification, illustrate embodiments of the invention and together with the description, and illustrate the principles of the invention.

FIG. 1 is directed to an embodiment of the instant invention depicting a flowchart of the herein described Business App and Consumer/Customer Web Browser. FIG. 1 further depicts a flow diagram with Business App login leading to create a Nudge™, select audience, publish, and then sent to advertising platforms or direct push. Consumer web browser shows search for restaurants and view Nudge™ results.

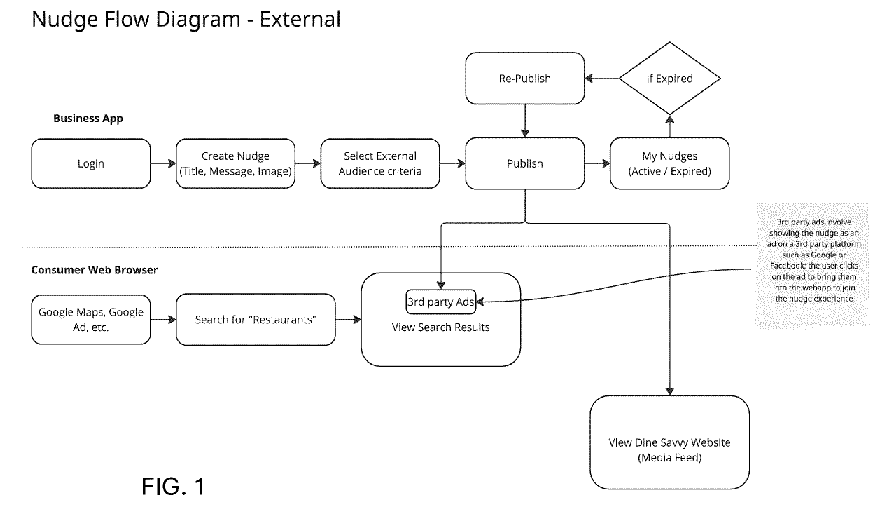

FIG. 2 is directed to an embodiment of the instant invention depicting a flowchart of the herein described Nudge™ Flow Business App and Consumer/Customer App. FIG. 2 further depicts a Nudge™ flow for customers (internal), with the Business App creating a Nudge™ pushed to the Customer App.

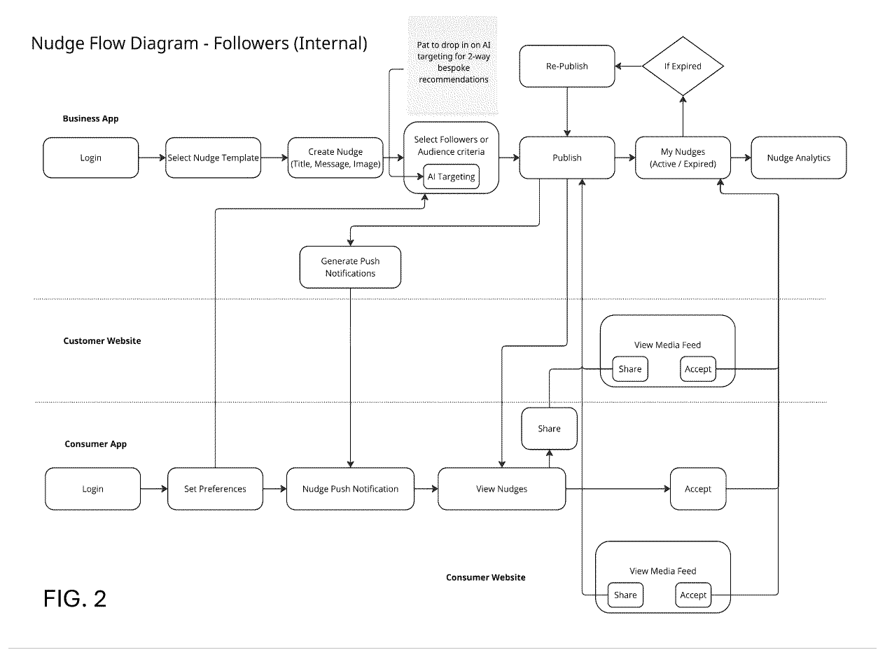

FIG. 3 is directed to an embodiment of the instant invention depicting a flowchart of the herein described Reverse Nudge™ Flow Business App and Consumer/Customer App. FIG. 3 further depicts a Reverse Nudge™ flow for customers (internal), with the Business App creating Nudge™ pushed to the Customer App.

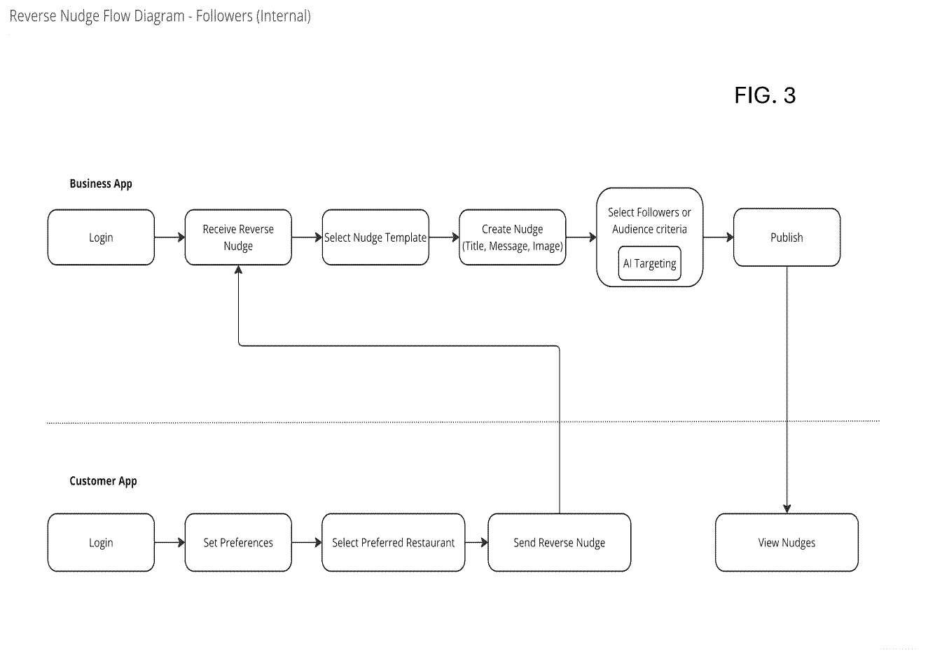

FIG. 4 is directed to an embodiment of the instant invention depicting a schematic diagram of the interactions between the Business App, a Backend Server, and Advertising Platform, and a Consumer/Customer App. FIG. 4 further depicts an External Nudge™ sequence with the Business App backend, advertising platform, and customer.

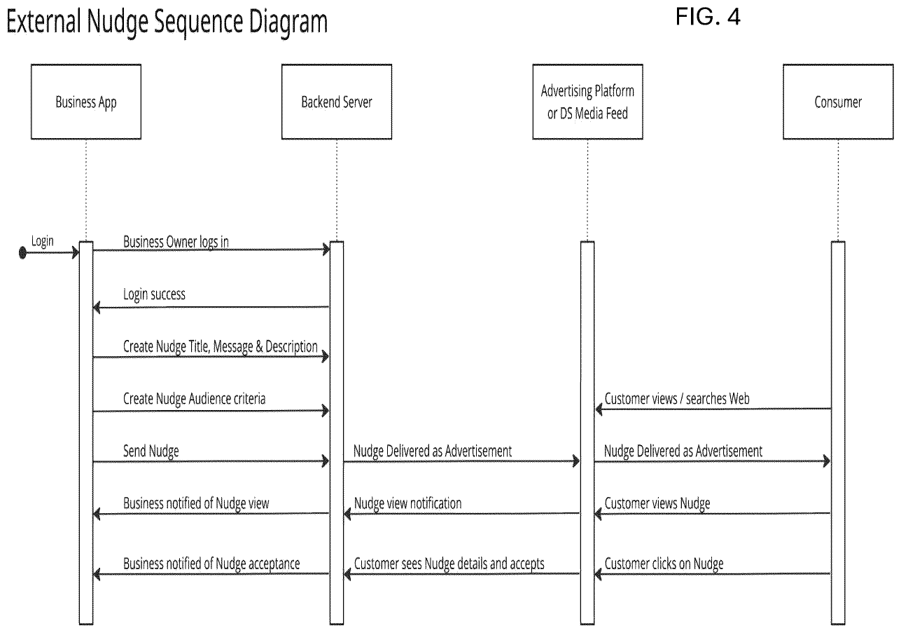

FIG. 5 is directed to an embodiment of the instant invention depicting a schematic diagram of Internal Nudge Sequencing between the Business App, a Backend Server, and a Consumer/Customer App. FIG. 5 further depicts an Internal Nudge™ sequence with the Business App backend and Customer App.

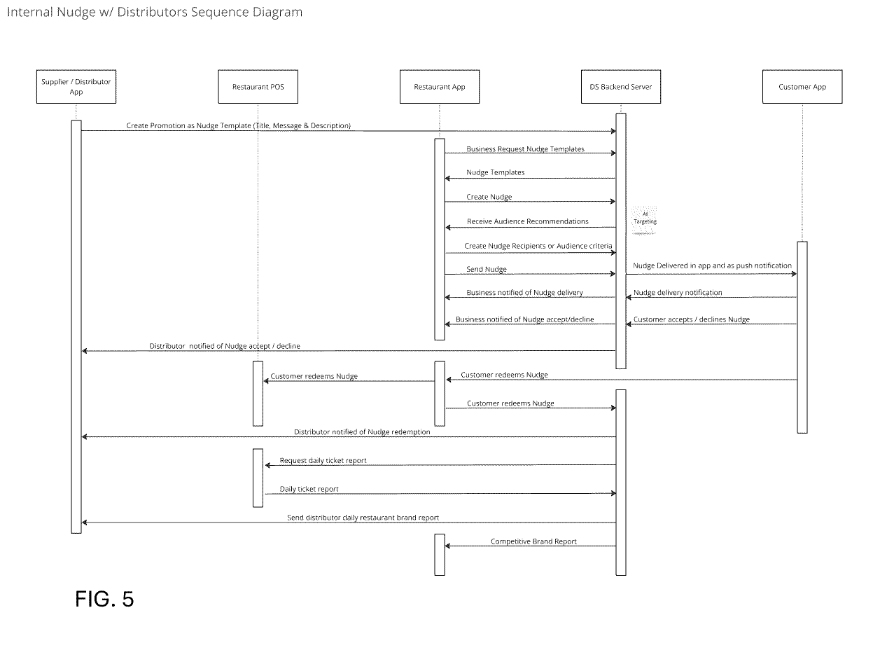

FIG. 6 is directed to an embodiment of the instant invention depicting a schematic diagram of Reverse Nudge Sequencing between a Business App, a Backend Server, and a Consumer/Customer App. FIG. 6 further depicts a Reverse Nudge™ sequence with the Customer App backend, and a Business App.

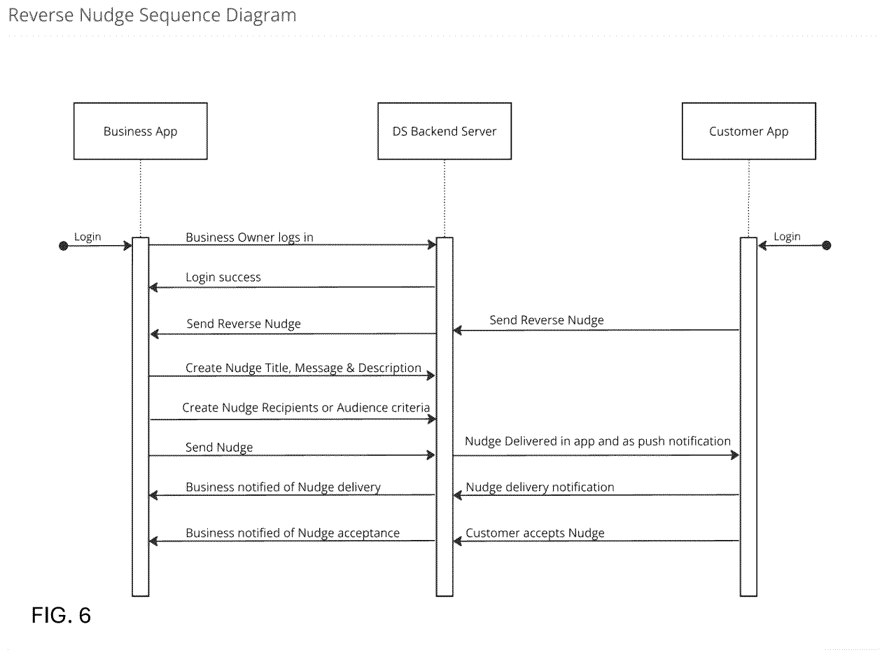

FIG. 7 is directed to an embodiment of the instant invention depicting a flow diagram related to Savvy Nudge™ and Super Nudge™ generation and processing.

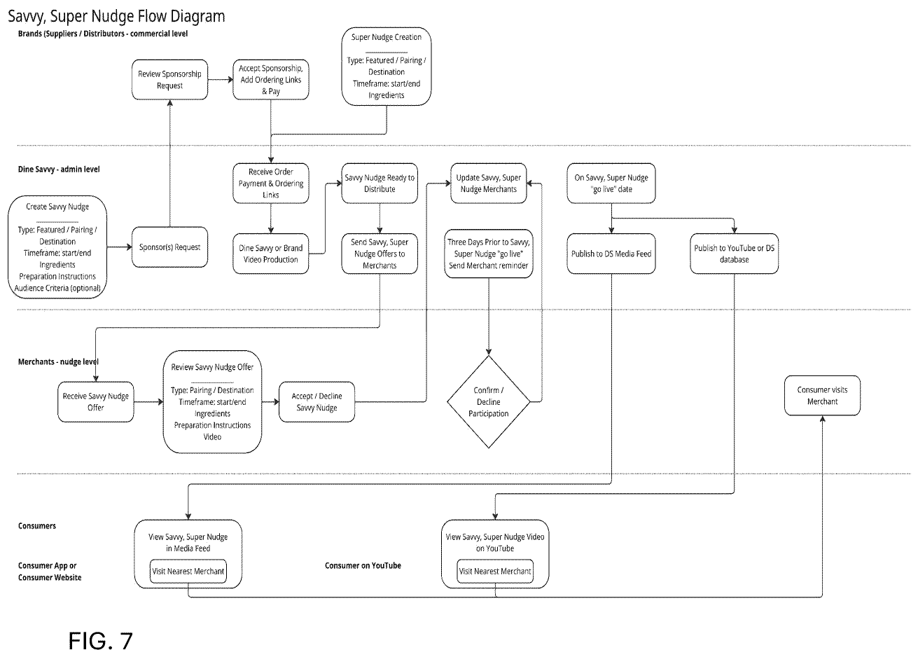

FIG. 8 is directed to an embodiment of the instant invention depicting a schematic sequence diagram of interactions and processing of Super Nudges™.

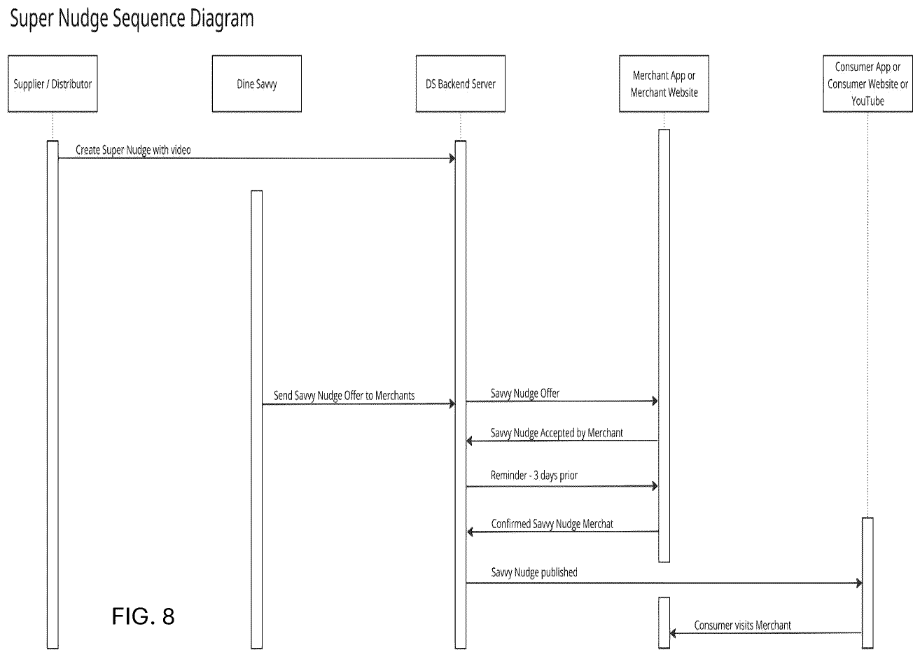

FIG. 9 is directed to an embodiment of the instant invention depicting a schematic sequence diagram of Media Feed sequencing.

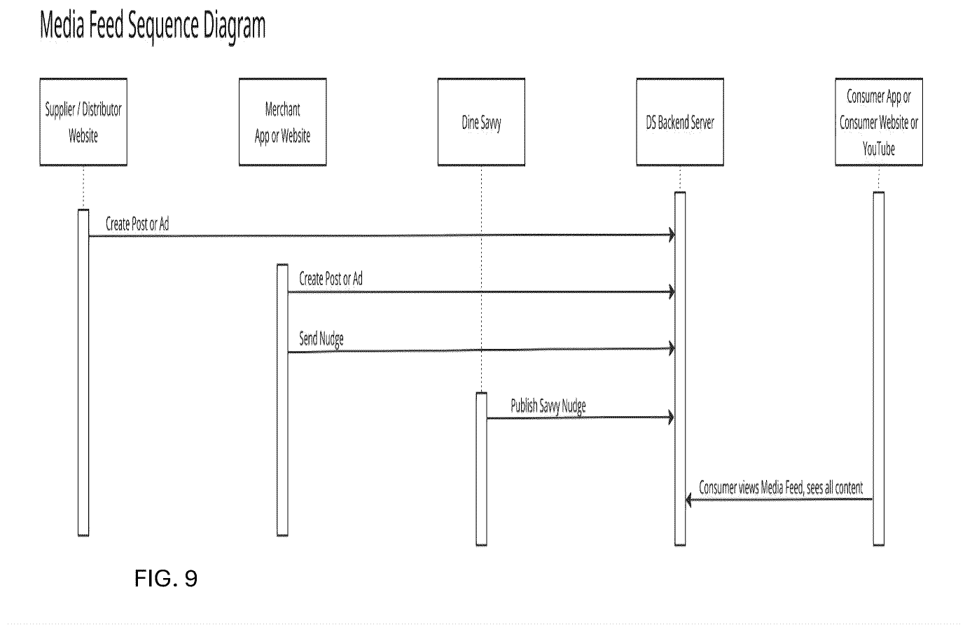

FIG. 10 is directed to an embodiment of the instant invention depicting a schematic diagram of the Dine Savvy™ Media Feed system, including content ingestion, Vibe Vector generation, personalization engine, aesthetic refinement, moderation, and delivery to Consumer App. FIG. 10 further depicts content flow from brands, merchants, consumers to Backend AI and Personalized Feed.

FIG. 11 is directed to an embodiment of the instant invention depicting an AI personalization process: Content Fingerprinting, Dynamic Matching, Aesthetic Refinement, and Quality Assurance. FIG. 11 further depicts a pipeline with Vibe Vector computation, similarity matching, AI styling, and moderation gate.

### DETAILED DESCRIPTION OF THE INVENTION

The application incorporates by reference the contents of the Appendix attached to the application.

In certain embodiments, the invention is directed to a system comprising: at least one hardware processor; and a non-transitory computer-readable storage medium having stored thereon program instructions, the program instructions executable by the at least one hardware processor to: receive product or service information from a business and customer preference information from a database; generating a data set comprising a plurality of transformations of said product or service information; apply, to each of said transformations, a trained machine learning model to obtain respective classifications with associated confidence scores derived from the customer preference information; compute a consensus classification and corresponding confidence score based on the classifications and scores; construct a re-training dataset comprising at least some of said transformations annotated with the consensus classification; re-train the machine learning model using the re-training dataset; and output personalized product or service offers (Nudges™) to customers via the Internet, mobile applications, or advertising platforms based on the consensus classification and confidence score.

Other objects of the invention are directed to a method comprising: receiving product or service information from a business and customer preference information from a database; generating a data set comprising a plurality of transformations of said product or service information; applying, to each of said transformations, a trained machine learning model to obtain respective classifications with associated confidence scores derived from the customer preference information; computing a consensus classification and corresponding confidence score based on the classifications and scores; constructing a re-training dataset comprising at least some of said transformations annotated with the consensus classification; re-training the machine learning model using the re-training dataset; and outputting personalized product or service offers (Nudges™) to customers via the Internet, mobile applications, or advertising platforms based on the consensus classification and confidence score.

Other objects of the invention are directed to a computer program product comprising: a non-transitory computer-readable storage medium having program instructions embodied therewith, the program instructions executable by at least one hardware processor to: receive product or service information from a business and customer preference information from a database; generate a data set comprising a plurality of transformations of said product or service information; apply, to each of said transformations, a trained machine learning model to obtain respective classifications with associated confidence scores derived from the customer preference information; compute a consensus classification and corresponding confidence score based on the classifications and scores; construct a re-training dataset comprising at least some of said transformations annotated with the consensus classification; re-train the machine learning model using the re-training dataset; and output personalized product or service offers (Nudges™) to customers via the Internet, mobile applications, or advertising platforms based on the consensus classification and confidence score.

In certain embodiments, the system includes a Reverse Nudge™ feature wherein customers solicit offers from businesses, and the system processes responses using the trained machine learning model to personalize and deliver counter-offers.

In certain embodiments the Nudges™ are generated by suppliers or distributors and distributed through merchants to end customers, integrating supply chain communications.

In certain embodiments, the output personalized offers are delivered via a social media feed comprising a plurality of content types including Posts, Nudges™, SuperNudges™, and SavvyNudges™.

In certain embodiments, the social media feed is personalized using a multi-stage AI pipeline comprising: a. generating a Vibe Vector for each content item; b. generating a User Vibe Vector based on user behavior, preferences, and context; c. computing similarity between User and Content Vibe Vectors; d. applying generative AI for aesthetic refinement; and e. performing automated content moderation before display.

Other objects of the invention are directed to a system for generating a personalized media feed, comprising: at least one hardware processor; and a non-transitory computer-readable storage medium having stored thereon program instructions executable to: receive a plurality of content items from brands, merchants, and consumers; generate a Vibe Vector for each content item using a trained machine learning model; generate a User Vibe Vector from user profile, behavior, and context; compute similarity scores between User and Content Vibe Vectors; rank and filter content based on similarity, location, and time; apply generative AI to refine visual and textual elements; perform automated moderation to remove objectionable content; and output a personalized Dine Savvy™ Media Feed to the user, integrating targeted Nudges™.

In certain embodiments, content items include SavvyNudges™ sponsored by brands and created by a platform operator.

In certain embodiments, user actions including “Cheers!”, “Share”, and “Go there!” are used to update the User Vibe Vector in real-time.

In certain embodiments, the media feed includes interactive elements enabling navigation to physical merchant locations based on geolocation data.

Other objects of the invention are directed to a method for personalizing a social media feed, comprising: receiving content from multiple sources; extracting a Vibe Vector for each content item; computing a User Vibe Vector; ranking content by Vibe Vector similarity and contextual relevance; refining content aesthetics using generative AI; moderating content for safety; and delivering a personalized feed integrating Nudges™.

In certain embodiments, the feed supports Reverse Nudges™ by allowing users to solicit and receive personalized offers in response to content interactions.

Other objects of the invention are directed to a computer program product including a non-transitory computer-readable storage medium having program instructions embodied therewith, the program instructions executable by at least one hardware processor to perform the methods of the invention.

One embodiment of the present invention described herein is called a “Nudge™”. It is an Internet system and method for businesses to send targeted messages and offers to their customers.

### Business App—Nudge™ Features

### 1. Operation:

Input: The Nudge™ system receives input from businesses including, but not limited to the following: Title of the Nudge, Message to send in the Nudge, Image to share as part of the Nudge.

Audience or Audience criteria to determine recipients of the Nudge™ may optionally be included because the inventive Nudge™ infrastructure primarily uses analytics, machine learning and artificial intelligence (AI) to recommend Audience recipients (potential customers) that will be most receptive to the Nudge™ offers.

In an embodiment of the instant invention, based on the criteria above, and other possible criteria and information, the inventive system and methods generates personalized Nudges™ and may deliver them to Customers directly in a mobile application, or optionally via push notifications to a mobile device, and/or via advertising platforms like Google Ads, Google Maps, or other advertising exchanges.

Processing: The inventive system and method may notify specified Customers or dynamically determines Nudge™ recipients based on Audience criteria input when creating the Nudge™.

Output: Based on the processing, the Business App generates personalized Nudges™ and delivers them to Customers via various communication channels such as push notifications, in-app notifications and advertising platforms.

### 2. Function:

Nudge™ Creation: Businesses can create and customize Nudges™ tailored to their target the Customers (or the Public via advertising platforms and VIP Customers with an affinity for the business via push and in-app notifications), such as product discounts, promotions, new product announcements, or reminders.

Nudges™ may be created by a merchant that patrons visit, or it may be input by a supplier and distributor that provide goods to the merchant.

These Nudges™ are then available to the merchant to send to the general public and/or their known customers/patrons. In this way, all members of the supply chain may use the Nudge™ system to provide promotions to their end users.

Automation: Nudges™ offer automation features, allowing businesses to set up scheduled campaigns or trigger-based Nudges™ based on specific events or customer actions.

Analytics and Insights: The inventive system and method provide analytics and insights on the effectiveness of Nudges™ and offers, including metrics such as open rates, click-through rates, conversion rates, return on investment (ROI), and the like.

Based on computer analytics, machine learning, and artificial intelligence (AI), the inventive Nudge™ system and method can help businesses target Nudges™ to audience segments that are most likely to be interested in and act upon received Nudges™.

### 3. Use:

Customer Engagement: Businesses may use Nudges™ to engage with their customers by sending timely and personalized information and offers, keeping them informed about new products, promotions, or events.

Increase Sales: By delivering targeted Nudges™, the inventive system and method enable businesses to drive sales, increase customer loyalty, and encourage repeat purchases.

Retention and Loyalty: Nudges™ help businesses retain customers and build loyalty by nurturing relationships, rewarding loyal customers with exclusive offers, and re-engaging inactive customers.

### Customer App—Nudge™ Features

### 1. Operation:

Input: The inventive Nudge™ system and method receives input from users including, but not limited to: preferences, behavior patterns, location data, preferred businesses, and further information a customer may provide during registration or through in-app interactions.

If the customer is not using a Nudge™ enabled application, they may still receive Nudges™ in advertising systems like Google Ad, Google Maps or other advertising exchanges. The customer preferences, behavior patterns, location data, etc. are disclosed to and “known” by the advertising system and accordingly used to target Nudges™ to customers.

### Consumer App and Website—Dine Savvy™ Media Feed

The instant inventive “Dine Savvy™ Media Feed” or simply “Media Feed”, is a social media feed that may features all relevant aspects of dining and populated by Posts, Nudges™, Super Nudges™, and Savvy Nudges™ from Dine Savvy™ affiliated food and beverage brands, suppliers, distributors, merchants, and consumers.

### Operation:

Input: Any user may access the Dine Savvy™ Media Feed by opening the Media Feed section of the Dine Savvy™ mobile apps or visiting the Dine Savvy™ website. The same feed is available in both locations and uses knowledge about a Consumer to personalize and prioritize the Media Feed content to the Customer's tastes and preferences.

An inventive Media Feed may comprise a variety of content, some described below:

### 1. Posts

a. Created by any member of a Dine Savvy™ network using the instant invention (Brands, Suppliers, Distributors, Merchants, or Consumers).
b. May include:
   i. Title
   ii. Media files (videos or images)
      1. User-provided (with or without AI augmentation) and/or
      2. AI-generated
   iii. Caption—text that accompanies the media
   iv. Target location—latitude and longitude where the media is relevant (may be left empty if there is no geographic target)
   v. Target audience criteria.

### 2. Savvy Nudges™

a. Created by Dine Savvy™ AI and sponsored by Brands Suppliers and Distributors.
b. May include:
   i. Title
   ii. Media—Videos
   iii. Caption—text that accompanies the media
   iv. Participating Merchants including their latitude and longitude to direct the Consumer to the nearest participating Merchant
   v. Timeframe—start and end dates
   vi. Target audience criteria

### 3. Super Nudges™

a. Created by Brands, Suppliers and Distributors
b. May include:
   i. Title
   ii. Media—Videos
   iii. Caption—text that accompanies the media
   iv. Participating Merchants including their latitude and longitude to direct the Consumer to the nearest participating Merchant
   v. Timeframe—start and end dates
   vi. Target audience criteria

### 4. Nudges™

a. Created by Merchants
b. May include:
   i. Title
   ii. Media files (videos or images)
      1. User-provided
      2. AI-generated
   iii. Caption—text that accompanies the media
   iv. Timeframe—start and end dates
   v. Target audience criteria

Apart from Savvy Nudges™ and Super Nudges™, content may be generated or modified by Dine Savvy™ AI to make the inventive system and method appealing to Consumers for use. The Dine Savvy™ AI system may also curate the content to ensure that no objectionable material is included in the Media Feed.

The inventive system and method may use Contextual Ambiance Targeting, which consist of an inventive multi-stage AI designed to deliver content seamlessly—including relevant sponsored posts or “Savvy Nudges™”—that perfectly align with customer personal tastes.

Output: With knowledge of a Consumer's demographics, preferences, and historic viewing behavior in the Media Feed, the inventive system and method sort the content so the most relevant content is delivered to the Consumer fostering high engagement. As a Consumer scrolls, their actions are analyzed by the inventive system to gain further understanding of interests. This information is used to further personalize and prioritize content. The inventive system may gather data as to what content was viewed, duration of view, “cheers” (liked), shares, and “Go there!” clicks. If location or Merchant data exists, the Customer user may click “Go there!”—another data point for personalization.

Processing: The inventive system and method categorize available consent and data in the Media Feed to understand the best audience for that content. This categorization is refined as Consumers view and engage with the Media Feed content to gain a better understanding of both the content itself and a Consumer's preferences.

Output: All metrics about the Consumer and Media Feed content consumption may be recorded to further understand the preferences of the Consumer and the audience to which the content appeals.

### Function:

Post Creation: Users create Posts via a guided UI to include a title, media content upload, caption, location tagging, and optional AI augmentation. AI would screen and curate for objectionable content before publishing.

Automation: the AI analyzes Posts to classify content type and target to aligned Consumers via identity signals (followed brands, merchants, etc.).

Analytics and Insights: Metrics (Cheers!, Shares, Go there!) are recorded and visible to content creators.

### 3. Use:

Consumer Engagement: Users share experiences; scroll immersive dining content.

Retention and Loyalty: Actions (Cheers!, Share, Go there!) signal interest and refine personalization.

### Merchant Mobile App and Website—Posts and Nudges™

Merchants may create Posts and Nudges™. Nudges™ which appear in the Media Feed during active timeframes.

Post Creation: Same flow as Consumer, with AI augmentation and moderation.

Analytics: Merchants view Cheers!, Shares, Go there! metrics.

Dine Savvy™—Savvy Nudges™ in Media Feed

Savvy Nudges™ may be Dine Savvy™ created, Brand-sponsored video promotions.

Function: Savvy Nudges™ may Include participating Merchant's “Go there!” and display nearest Merchant locations.

Production and Broadcast: Dine Savvy™ produces video, broadcasts to eligible Merchants for acceptance (with fulfillment links), and then to Consumers.

### Brands—Super Nudges™ in Media Feed

Super Nudges™ are Brand-created versions without Dine Savvy™ sponsorship.

### Brands—Posts

Brands create Posts via a business portal with AI augmentation and moderation.

It is contemplated that the instant invention includes a 4-Step Personalization Process for Posts and Nudges™.

### 4-Step Personalization Process:

### 1. Content Fingerprinting: The “Vibe Vector”

Content (photos, videos, Posts, and Nudges™) are analyzed by the inventive Dine Savvy™ AI and converted into a unique mathematical signature called a “Vibe Vector”. This digital fingerprint captures the emotional and stylistic essence of the content (e.g., its mood, energy, or aesthetic), creating a machine-readable map of the content “emotional landscape”.

### 2. Dynamic Matching: The Perfect Curated Feed

A personalized media feed may be generated using a “Vibe Vector,” an evolving mathematical profile of customer preferences, learned from customer in-app input and interaction. Content (including aligned Savvy Nudges™ or sponsored Posts) with a closest Vibe Vector match—considering current context (time and location)—is prioritized for relevance and minimal intrusion.

### 3. Aesthetic Refinement: The AI Stylist

Displayed content would conform to a “Divine Savvy™ Brand Vibe Vector” for a cohesive experience. The inventive system and method Dive Savvy™ AI automatically polishes personalized posts with visual filters or caption adjustments to ensure a seamless, high-quality aesthetics.

### 4. Quality Assurance: The Final Safety Check

Content may be reviewed by a specialized Dine Savvy ™ AI model before publication to detect and block objectionable or unsafe material automatically from reaching system and method users.

This integrated approach combining emotional analysis, dynamic user profiling, contextual relevance, and automated aesthetic polish delivers a hyper-personalized, visually pleasing, and safe media experience.

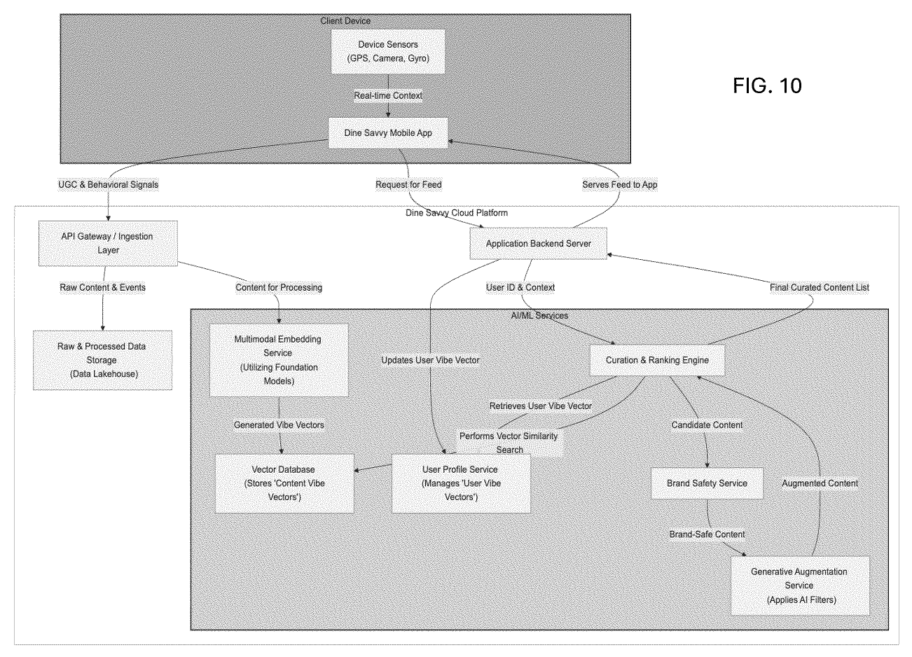

Referring to FIG. 10, which depicts an inventive system architecture diagram showing the components of the invention. The Client Device, which includes the Mobile App and Device Sensors, captures user-generated content (UGC), behavioral signals, and real-time context. This data is sent to the Dine Savvy Cloud Platform via an API Gateway. Within the platform, AI/ML Services perform the core inventive functions. The Multimodal Embedding Service converts content into “Vibe Vectors,” which are stored in a Vector Database. The User Profile Service maintains each user's dynamic profile. When a feed is requested, the Application Backend communicates with the Curation & Ranking Engine, which uses the user's profile and vector search to retrieve candidate content. This content is then filtered by the Brand Safety Service and enhanced by the Generative Augmentation Service before the final list is sent back to the client device.

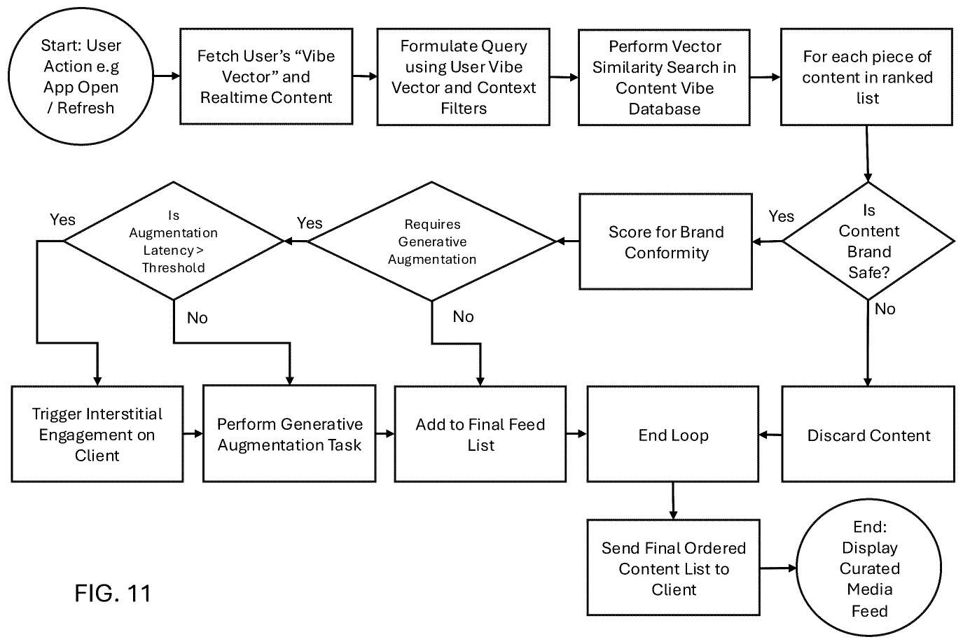

Referring to FIG. 11, which depicts flowchart detailing a core method of the invention.

The flowchart illustrates a process for curating and displaying a personalized media feed based on user actions, incorporating elements like Vibe Vectors, similarity searches, augmentation, and brand safety checks. The flow is triggered by user interactions and involves looping through content items with decision points. Below is a sequential breakdown of the steps, following the logical path from start to end, including branches for decisions.

Start: User Action (e.g., App Open/Refresh) The process begins when the user performs an action, such as opening the application or refreshing the feed. This serves as the entry point.

Fetch User's “Vibe Vector” and Realtime Content Retrieve the user's personalized “Vibe Vector” along with any realtime content updates.

Formulate Query using User Vibe Vector and Context Filters Construct a search query by combining the user's Vibe Vector with additional context filters (e.g., location, time, or other parameters) to tailor the content retrieval.

Perform Vector Similarity Search in Content Vibe Database Execute a vector-based similarity search against a database of content vibes to identify relevant items. This generates a ranked list of content pieces based on similarity to the user's query.

For Each Piece of Content in Ranked List (Start of Loop) Iterate through each item in the ranked list one by one. For each content piece, the following sub-steps and decisions occur:
a. Decision: Is Augmentation Latency >Threshold? Evaluate if the expected latency for augmenting the content exceeds a predefined threshold (e.g., to avoid delays in user experience).

Yes: Proceed to “Trigger Interstitial Engagement on Client” (a side action to show temporary engaging content, like ads or loaders, on the user's device while processing continues). The main flow then proceeds to the next decision.

No: Skip the interstitial and proceed directly to the next decision.
b. Decision: Requires Generative Augmentation? Determine if the content needs generative augmentation (e.g., AI-generated enhancements like summaries, translations, or modifications).

Yes: Perform the “Generative Augmentation Task” to apply the necessary changes. Then proceed.

No: Skip augmentation and proceed.
c. Score for Brand Conformity Calculate a score assessing how well the content aligns with brand guidelines or standards (e.g., relevance, tone, or compliance).
d. Decision: Is Content Brand Safe? Check if the content meets brand safety criteria based on the conformity score (e.g., free from inappropriate, harmful, or off-brand elements).

Yes: Add the content to the “Final Feed List” (an ordered collection of approved items).

No: “Discard Content” (remove it from consideration and do not add it to the feed).

End Loop After processing the current content piece (whether added or discarded), return to step 5 to handle the next item in the ranked list. Repeat until all pieces are processed.

Send Final Ordered Content List to Client Once the loop completes for all content, transmit the curated and ordered final feed list to the client's device.

End: Display Curated Media Feed The process concludes by rendering and displaying the curated media feed to the user.

The present invention may be and include a system, a method, and/or a computer program product.

The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A system comprising:
at least one hardware processor; and
a non-transitory computer-readable storage medium having stored thereon program instructions, the program instructions executable by the at least one hardware processor to:
receive product or service information from a business and customer preference information from a database;
generating a data set comprising a plurality of transformations of said product or service information; apply, to each of said transformations, a trained machine learning model to obtain respective classifications with associated confidence scores derived from the customer preference information;
compute a consensus classification and corresponding confidence score based on the classifications and scores;
construct a re-training dataset comprising at least some of said transformations annotated with the consensus classification;
re-train the machine learning model using the re-training dataset; and
output personalized product or service offers (Nudges™) to customers via the Internet, mobile applications, or advertising platforms based on the consensus classification and confidence score.

2. The system of claim 1, further comprising a Reverse Nudge™ feature wherein customers solicit offers from businesses, and the system processes responses using the trained machine learning model to personalize and deliver counter-offers.

3. The system of claim 1, wherein the Nudges™ are generated by suppliers or distributors and distributed through merchants to end customers, integrating supply chain communications.

4. The system of claim 1, wherein the output personalized offers are delivered via a social media feed comprising a plurality of content types including Posts, Nudges™, SuperNudges™, and SavvyNudges™.

5. The system of claim 4, wherein the social media feed is personalized using a multi-stage AI pipeline comprising:
a. generating a Vibe Vector for each content item;
b. generating a User Vibe Vector based on user behavior, preferences, and context;
c. computing similarity between User and Content Vibe Vectors;
d. applying generative AI for aesthetic refinement; and e. performing automated content moderation before display.

6. A method comprising:
receiving product or service information from a business and customer preference information from a database;
generating a data set comprising a plurality of transformations of said product or service information;
applying, to each of said transformations, a trained machine learning model to obtain respective classifications with associated confidence scores derived from the customer preference information;
computing a consensus classification and corresponding confidence score based on the classifications and scores;
constructing a re-training dataset comprising at least some of said transformations annotated with the consensus classification;
re-training the machine learning model using the re-training dataset; and
outputting personalized product or service offers (Nudges™) to customers via the Internet, mobile applications, or advertising platforms based on the consensus classification and confidence score.

7. A computer program product comprising:
a non-transitory computer-readable storage medium having program instructions embodied therewith, the program instructions executable by at least one hardware processor to:
receive product or service information from a business and customer preference information from a database;
generate a data set comprising a plurality of transformations of said product or service information; apply, to each of said transformations, a trained machine learning model to obtain respective classifications with associated confidence scores derived from the customer preference information;
compute a consensus classification and corresponding confidence score based on the classifications and scores;
construct a re-training dataset comprising at least some of said transformations annotated with the consensus classification;
re-train the machine learning model using the re-training dataset; and
output personalized product or service offers (Nudges™) to customers via the Internet, mobile applications, or advertising platforms based on the consensus classification and confidence score.

8. A system for generating a personalized media feed, comprising:
at least one hardware processor; and
a non-transitory computer-readable storage medium having stored thereon program instructions executable to:
receive a plurality of content items from brands, merchants, and consumers; generate a Vibe Vector for each content item using a trained machine learning model;
generate a User Vibe Vector from user profile, behavior, and context; compute similarity scores between User and Content Vibe Vectors;
rank and filter content based on similarity, location, and time;
apply generative AI to refine visual and textual elements; perform automated moderation to remove objectionable content; and
output a personalized Dine Savvy™ Media Feed to the user, integrating targeted Nudges™.

9. The system of claim 8, wherein content items include SavvyNudges™ sponsored by brands and created by a platform operator.

10. The system of claim 8, wherein user actions including “Cheers!”, “Share”, and “Go there!” are used to update the User Vibe Vector in real-time.

11. The system of claim 8, wherein the media feed includes interactive elements enabling navigation to physical merchant locations based on geolocation data.

12. A method for personalizing a social media feed, comprising:
receiving content from multiple sources;
extracting a Vibe Vector for each content item;
computing a User Vibe Vector;
ranking content by Vibe Vector similarity and contextual relevance;
refining content aesthetics using generative AI;
moderating content for safety; and
delivering a personalized feed integrating Nudges™.

13. The method of claim 12, wherein the feed supports Reverse Nudges™ by allowing users to solicit and receive personalized offers in response to content interactions.

14. A computer program product comprising a non-transitory computer-readable storage medium having program instructions embodied therewith, the program instructions executable by at least one hardware processor to perform the method of claim 12.
